(19) United States
(12) Patent Application Publication
(10) Pub. No.: US 2020/0199437 A1
(43) Pub. Date: Jun. 25, 2020

(54) DRILLING FLUID FOR HYDROCARBON WELLS AND MANUFACTURING PROCESS THEREOF

(71) Applicant: ORINOCO DRILLING FLUIDS LLC, CAPE CORAL, FL (US)

(72) Inventor: LUIS TELLIS, ANZOATEGUI (VE)

(21) Appl. No.: 16/620,810

(22) PCT Filed: Apr. 19, 2018
(86) PCT No.: PCT/US18/28383

§ 371 Date: Dec. 9, 2019

Related U.S. Application Data
(60) Provisional application No. 62/487,159, filed on Apr. 19, 2017.

(51) Int. Cl. C09K 8/524; C09K 8/04

(52) U.S. Cl. CPC C09K 8/524; C09K 2208/06; C09K 8/04

(57) ABSTRACT

The invention relates to a drilling fluid resulting from a combination of calcium carbonate, starch, calcium oxide, xanthan gum, and essentially a cationic surfactant, where the cationic surfactant is constituted by the following components: calcium nitrate, diethanolamine (DEA), and glacial acetic acid. Also disclosed is a method for producing the cationic surfactant, a process for obtaining the drilling fluid, as well as a method for measuring the free calcium of the reaction when the fluid is in wellbore operation.

### CROSS-REFERENCE TO RELATED APPLICATIONS

This application claims the benefit of U.S. Provisional Application No. 62/487,159, filed Apr. 19, 2017, which is incorporated herein in its entirety.

### BACKGROUND OF THE INVENTION

### 1. Field of the Invention

The present invention concerns a cationic surfactant for drilling fluids. In particular, the invention concerns a cationic surfactant that includes diethanolamine, calcium nitrate and glacial acetic acid and is capable of inhibiting precipitation of the asphaltenes from hydrocarbon fluid during a drilling operation.

### 2. Description of Related Art

The fundamental goal of drilling fluids is to improve the efficiency of the operation, which translates into helping to make drilling a well quick and safe. The main functions of drilling fluids include: 1) providing hydrostatic pressure to prevent formation fluids from entering the wellbore; 2) keep the auger cold and clean during drilling; 3) carry the drill cuts and hold them in suspension when the operation stops and when the drill assembly is introduced and withdrawn from the well.

The drilling fluid to be used in a particular task is chosen mainly under the criteria of avoiding damages to the producing formation and to limit the corrosion. The functions of the drilling fluid describe the tasks that the drilling fluid is capable of performing, although some of these are not essential in each well. Removal of well cutouts and control of formation pressures are extremely important functions.

Other particularly important problems are the swelling of the clays, which causes difficulties of dragging, jamming and even loss of tools and possible loss of the perforated well, in addition to the formation of plastic amalgam, which leads to the clogging of the meshes and cones of solids-control equipment.

The state of the art reports multiple drilling fluid technologies, among which are the following, as the closest to the technology proposed by the present invention.

By way of example, U.S. Pat. No. 4,148,736 to Meister discloses the viscosified surfactant compositions relating to fracturing fluids and additives in the drilling mud. The cationic surfactant present in the composition of this invention is selected from the group of compounds consisting of amine quaternary ammonium salts.

In another example, U.S. Pat. No. 5,771,971 to Horton et al. describes an alternate stabilizing agent comprising at least one organic amine selected from the group consisting of primary diamines with a chain length of 8 or less, and primary alkyl amines with a chain length of 4 or less as odor-free clay stabilizing agent that removes the chlorides.

In yet another example, U.S. Patent Application Publication No. 20100222241 to Merli et al., discloses clay hydration inhibitors that include 1,2-cyclohexanediamine and/or salts thereof for the drilling industry, to promote inhibition and reduce swelling of clays and shales that come in contact with the fluids used in the drilling.

While various additives, surfactants and stabilizers for drilling fluids have been described, there remains a need for economical drilling fluids that inhibit the precipitation of asphaltenes from a crude oil, stabilizes clays and shales, or both.

### SUMMARY OF THE INVENTION

A discovery had been made that overcomes afore-mentioned problems. The discovery is premised on a cationic surfactant derived from the reaction product of calcium nitrate diethanolamine (DEA) and glacial acetic acid. The cationic surfactant can be comprised in a drilling fluid for hydrocarbon production from subterranean formations. The drilling fluid can also include, starch, calcium oxide, viscosifiers, and densifiers. The drilling fluid of the present invention can confer the technical advantages of facilitating the emulsification of the oil or resin in the drilling fluid, which is achieved by the saponification of asphaltenes. Without wishing to be bound by theory, it is believed that the asphaltenes in the crude oil form asphaltenes micelles with the cationic surfactant, thus allowing the asphaltenes to undergo a chemical reaction (e.g., reduction in molecular weight) with base and/or gases in the crude oil (e.g., carbon dioxide (C0₂) and precipitating the reaction products.

Another advantage of the embodiment of this invention is to reduce the swelling of the clays and shales and to prevent the formation of the plastic amalgam which leads to the clogging of the meshes and cones of solids-control equipment.

Additionally, the present invention seeks to exert an analytical control of the active agent in the field, in particular the concentration of free calcium which forms part of the formulation of the fluid. In addition, means are provided for performing organoleptic checks such as visual appreciation of cuts and hardness of cuts by tactile appreciation.

Another object of the present invention is to significantly reduce the adhesion of the clays and shales to the metal parts and tools which are introduced into the hole for drilling thereof.

Another contribution intended by the present invention is to be an environmentally-friendly solution for a drilling site, whether terrestrial or aquatic, being non-toxic and reusable, properties absent in another polymer-based drilling fluid.

Another object of the invention is resistance to bacterial action.

A further object of the invention is to reduce water absorption of clays and shales, reducing swelling at the wellbore wall. The reduction of the volume of water absorption is achieved by the chemical modification of the clay particle structure, which leads to the reduction of the swelling at the wellbore wall and thus the reduction of the diameter thereof.

A further object of the invention is to prevent dissolved solids in the crude oil from precipitating into the fluid, mixing with the forming clay, sand and the fluid itself, thereby forming the plastic amalgams.

And yet a final object of the present invention is to generate the ability to emulsify in the fluid the crude oil incorporated during the drilling of the wellbore without affecting the properties of the drilling fluid, while preventing the formation of amalgams.

To address the proposed objects, the invention discloses the use of a cationic surfactant composition that includes calcium nitrate, diethanolamine (DEA), and glacial acetic acid. In another preferred embodiment of the invention, there is provided a method for preparing the cationic surfactant of the present invention.

In another preferred embodiment of the invention, a drilling fluid includes the cationic surfactant of the present invention a viscosifier such as xanthan gum, an alkalizing agent, such as calcium oxide, and optionally the use of a densifier, such as calcium carbonate.

In another preferred embodiment of the invention, there is a method for obtaining a drilling fluid, in accordance with the gradual and systemic combination of the aforementioned elements.

Further, m another preferred embodiment of the invention, there 1 s a method for measuring free calcium in the reaction when the fluid is in operation.

The following includes definitions of various terms and phrases used throughout this specification.

The terms “pound (lb)” or “pound mass (lbm)” are to be understood as equivalent, and not to be confused with pound force (lbf), which is not applicable to the present invention.

The phrase “free calcium” refers to Ca⁺² ions that dissociated from counter ion compounds. By way of example, the Ca⁺² ions are dissociated from calcium nitrate (CaN0₃), and CaO and are not associated with the surfactant or any other compound in the drilling fluid (e.g. CaC03, Ca(OH)2).

The term “about” or “approximately” are defined as being close to as understood by one of ordinary skill in the art. In one non-limiting embodiment, the terms are defined to be within 10%, preferably within 5%, more preferably within 1%, and most preferably within 0.5%.

The term “substantially” and its variations are defined to include ranges within 10%, within 5%, within 1%, or within 0.5%.

The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The cationic surfactants and/or drilling fluids comprising the cationic surfactants of the present invention can “comprise,” “consist essentially of,” or “consist of’ particular ingredients, components, compositions, etc. disclosed throughout the specification. With respect to the transitional phase “consisting essentially of,” in one non-limiting aspect, a basic and novel characteristic of the cationic surfactants and/or drilling fluids comprising the cationic surfactants of the present invention are their abilities to inhibit asphaltenes precipitation during a hydrocarbon drilling operation.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description.

### BRIEF DESCRIPTION OF THE FIGURES

Advantages of the present invention may become apparent to those skilled in the art with the benefit of the following detailed description and upon reference to the accompanying drawings.

FIG. 1 is a chart showing bentonite swelling (%) vs Time (min) in contact with the drilling fluid of the present invention.

FIG. 2 is a chart showing dynamic swelling of a sediment sample (%) vs. time (hrs.) in contact with the drilling fluid of the present invention.

FIG. 3 is a chart showing the results of % v/v and pounds per barrel (lbs./bbl.) vs. Ca⁺² Concentration, corresponding to field tests of the invention.

While the invention is susceptible to various modifications and alternative forms, specific embodiments thereof are shown by way of example in the drawings. The drawings may not be to scale.

### DESCRIPTION OF THE INVENTION

The present invention provides a solution the problems associated with many drilling fluids (e.g., precipitation of asphaltenes during use and/or destabilized clay and/or shale). The solution is premised on a cationic surfactant that includes calcium nitrate, diethanolamine (DEA), and glacial acetic acid. The cationic surfactant can be comprised in a drilling fluid. The drilling fluid of the present invention can be added to a wellbore during a drilling process to I) allow precipitation of asphaltenes reaction products and/or 2) inhibit swelling of clays or shale. Without wishing to be bound by theory, it is believed that the mechanism that allows precipitation of the asphaltenes present in crude oil is established between diethanolamine and glacial acetic acid, when the crude oil is incorporated from the deposit to the drilling fluid in contact with the formation, the gases associated to the crude oil, i.e. CO₂ expansion and chemical reaction with the asphaltenes, precipitating the reaction products.

### A. Cationic Surfactant

The cationic surfactant alone can inhibit precipitation of asphaltenes, inhibit swelling of clay and/or shale, provide anti-bacterial action, emulsify any type of crude that is incorporated into the fluid during the drilling of a reservoir, and the ability to be stored for reuse are properties provided by the environmentally-friendly surfactant.

The cationic surfactant composition of the present invention can include calcium nitrate, DEA and glacial acetic acid. The amount of DEA can be 2 to 5 vol. %, 3 to 4 vol. %, or 2, 3, 4, 5 vol. % or any value or range there between of diethanolamine. Glacial acetic acid can be present in about 0.5 to 2 vol. %, 1 to 1.5 vol. %, or 0.5, 1, 1.5, 2 vol. %, or any range or value there between. A 53-57 vol. % calcium nitrate solution can be present in 92 to 97 vol. %, 93 to 96 vol. %, 94 to 95 vol. %, or 92, 93, 94, 95, 96, 97 vol. %, or any range or value there between. The calcium nitrate, DEA and glacial acetic acid can be obtained from various commercial sources. A non-limiting example of a commercial source is Sigma-Aldrich® (USA). In some embodiments, the calcium nitrate is prepared by reacting aqueous nitric acid and calcium carbonate. The nitric acid can include 56 wt. % and 66 wt. % of nitric acid, preferably between 62 wt. % and 65 wt. %, and calcium carbonate can have a purity of 89% to 99%, preferably 97 to 99% (i.e., 96 to 99 wt. % calcium carbonate).

In some embodiments, the cationic surfactant composition can be prepared by combining the calcium nitrate, diethanolamine and then acidify the solution with glacial acetic acid to form the cationic surfactant. In some embodiments, the cationic surfactant is prepared in the following manner. In a first step, calcium nitrate can be prepared by combining a desired amount of aqueous nitric acid with a stoichiometric amount of calcium carbonate at a temperature of 50 to 70° C., preferably 60° C. with agitation to form calcium nitrate in a concentration of 53 to 57 vol. %, preferably 54 to 56 vol. %, or 53, 54, 55, 56, 57 vol. %, or any range or value there between. The pH of the solution can be neutralized or adjusted to a neutral pH (e.g., pH of 6.5 to 7.5, or about 7) with the addition of calcium oxide. To this solution 2 to 5 vol. % of diethanolamine can be added at 22 to 25° C. with agitation to form the calcium salt of diethanolamine. The nitrogen of the diethanolamine can be protonated by addition of glacial acetic acid to form the cationic surfactant. The amount of glacial acetic acid can be 0.5 to 2 vol. %, 1 to 1.5 vol. %, or 0.5, 1, 1.5, 2 vol. % or any range or value there between. In some embodiments, the cationic surfactant can have a general structure of:

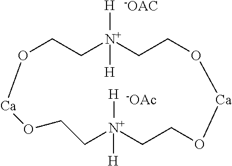

In other structure embodiments, the surfactant is a linear molecule.

### B. Drilling Fluids

The cationic surfactant of the present invention can be combined with other components to produce a drilling fluid suitable for use in subterranean hydrocarbon formations. The drilling fluid can include viscosifiers, alkalinizing agents, densifiers, control agents or other components.

1. Viscosifiers

Viscosifiers are materials that provide a suitable viscosity for carrying the drilled cuttings in tangential vertical or horizontal wells, as well as capacity to keep the cutting in suspension, maintain optimal fluid thixotropic properties, and optional lubricity and emulsification. Non-limiting examples of viscosifiers include clays, mixed metal hydroxides, carboxylic acid polymers, crosslinked polyacrylate polymers, polyacrylamide polymers, polysaccharides, biopolymers and gums. In a preferred embodiment, the viscosifier is xanthan gum. The xanthan gum can be added in amounts suitable to obtain a concentration of 1.2-1.6 lbm/bbl. (3.42 to 4.56 kg/m³). In a preferred embodiment, the viscosifier is xanthan gum. The xanthan gum can be added in amounts suitable to obtain a concentration of 1.2-1.6 lbm/bbl. (3.42 to 4.56 kg/m³).

2. Filtration Loss Control Agents

The drilling fluid can include one or more control agents. The control agent can manage filtration rate, filtration volume, and filter cake thickness and permeability, thus reducing the amount of filtrate lost from the filling fluid into a subsurface formation. Lowering the filtration rate can effectively reduce the reaction of the drilling fluid with the surrounding formation, thus contributing to borehole stability and controlling the borehole geometry. Non-limiting examples of control agents include clays (e.g., bentonite), polymers cellulosic polymers, modified natural cellulosic polymers, starch or combinations thereof. In a preferred embodiment, the drilling fluid can include starch in a concentration of 4 to 6 lbm/bbl. (11.4 to 17.1 kg/m³), or 4, 5, 6 lbm/bbl. (11.4, 14.2, 17.1 kg/m³), or any value or range there between.

3. Alkalinity Agents

The drilling fluid can include one or more alkalinity agents. The alkalinizing agent can be used to control the pH of the drilling fluid. By way of example, the drilling fluid can have a pH of 10.5 to 11. Non-limiting examples of alkalinity agents include soda ash (sodium carbonate), lime, calcium oxide, potassium hydroxide, caustic soda (sodium hydroxide), magnesium oxide, or magnesium peroxide, or mixtures thereof. In a preferred embodiment, the drilling fluid can include calcium oxide in a concentration of 0.4 to 1.4 lbm/bbl. (1.14 to 3.99 kg/m³), or 0.4, 0.5, 0.6, 0.7, 0.8, 0.9, 1.0, 1.2, 1.3, 1.4 lbm/bbl. (1.14, 1.43, 1.71, 2.0, 2.28, 2.57, 2.85, 3.42, 3.71, or 3.99 kg/m3), or any value or range there between. In some embodiments, calcium oxide can provide an additional source of calcium ion (e.g., free calcium). In water, the alkalinity agent can form metal hydroxides, which can activate, maintain or promote cation exchange with of ions in clay or shale at pH values above 10. In the most preferred embodiment, the alkalizing agent has a cation that is equal or similar to the cation of the active agent (e.g., Ca⁺²), in order to decrease the probability of competition for occupying the active center of the clay particle.

4. Densifiers

The drilling fluid can include one or more densifiers. Densifiers can be compounds that increase the density of the drilling fluid and can be dispersed or solubilized in the drilling fluid. Densifiers are useful to help control formation pressure, and/or combat effects of sloughing or heaving shales that can be encountered in stressed areas. Densifiers can also thicken or viscosify the drilling fluid. The use of densifiers in the formulation is optional, and in that sense any thickener existing in the art may be used, the concentration thereof will depend on the density value required (e.g., density greater than density of water), being a non-restrictive element over the whole of the present invention. In a preferred embodiment, the drilling fluid can include calcium carbonate in a concentration 95-105 lbm/bbl. (270-299.24 kg/m³) as a densifier. Preferably, a densifier is calcium carbonate, optionally could be barite, galena, hematite, ilmenite or combinations thereof. Hematite can be obtained under the trade name ORIMATITA® by Petroleos de Venezuela, S.A. (PDVSA) with a specific gravity between 4.8 g/cc to 5.1 g/cc. Barite can be obtained from BAROID® Industrial Drilling Products under the tradename BAROID®.

The above described components can be combined to form a drilling fluid of the present invention. In a first step, a volume of water needed to prepare the required volume of drilling fluid can be added to a preparation tank. The volume of water can be determined by subtracting the volume displacement of the viscosifier, optional densifier, and considering the increase of density of water caused by the other components of the formulation of 0.5-0.8 LPG. By way of example, considering the density of water with the rest of the components of the formulation of 8.4-8.5 LPG, the volume of water can be 86-91% bbl. (about 13.7% to 14.5%) m³ and 104 lbm (47.17 kg) of calcium carbonate, considering as a basis of calculation one barrel of fluid densified with calcium carbonate at 10 LPG. “LPG” means Lbs./Gal.

In step 2, the viscosifier described below (e.g., xanthan gum) can be added to the water under agitation. The viscosifier can be added at a rate sufficient to inhibit the formation of aggregates or hydrated globules (“fish eyes”). In step 3, 1 to 3 vol. % or 1, 1.5, 2, 2.5, or 3 vol. % or any value or range there between of the cationic surfactant of the present invention can be added to the viscosified water. In step 4, the alkalinity agent can be added to adjust the pH to greater than 10 (e.g., 10 to 11 or 10.5 to 11, or 10, 10.1, 10.2, 10.3, 10.4, 10.5, 10.6, 10.7, 10.8, 10.9, or 11, or any range or value there between). In step 5, an optional densifier can be added. After all the ingredients have been added to the water, the solution can be agitated for 55 to 105 minutes, 60 to 100 min., 70 to 90 min, or any range or value there between.

### C. Determination of Free Calcium in the Fluid

In some embodiments, it is desirable to know amount of active agent in the fluid in the formation during the drilling operation so that the drilling fluid formulation can be adjusted to provide more or less active agent (e.g., Ca⁺²). A method of determining the free calcium can include obtaining a solution that include calcium free water and a calcium ion indicator. In a preferred embodiment, the calcium indicator is ammonium-2,6-dioxo-5-[(2,4,6-trioxotetrahydro-5(2H)-pyrimidinyliden)amino]-1,2,3,6-tetrahydro-4-pyrimidinolat, commonly known as Murexide or ammonium purpurate. Such an indicator is available from various commercial sources (e.g., Sigma-Aldric®). In a calcium-free water solution, the solution can have a violet color. An analyte can be obtained from the drilling fluid in the wellbore and then be added to the water solution containing the calcium ion indicator. If the solution remains violet in color, no calcium is present. If the solution turns red, free calcium is present. To determine the amount of free calcium, the solution can be titrated with a known molarity of ethylenediaminetetraacetic acid (EDTA) that is equivalent to a known amount of CaC0₃ (equivalence number) until the solution returns to the violet color and recording the volume of EDTA solution used. In a non-limiting example, a 0.5 M solution of EDTA can be used, which is equivalent to 2000 ppm CaC0₃). The concentration of free calcium can then be calculated by multiplying the EDTA volume used by the equivalence number (e.g., 2000). In embodiments, where the water used to make the indicator solution turn red when the indicator is added, the residual calcium can be complexed with a 0.01 M solution of EDTA (e.g., 40 ppm). In a specific embodiment, the titration procedure is as follows:
(a) In a 50 ml graduated cylinder, measuring 50 milliliters of distilled water and add it to a 250-milliliter flask.
(b) Adding dropwise IN sodium hydroxide solution to pH value between 12-13, add between 0.3 and 0.5 grams of Murexide indicator. If the water turns light red, it indicates the presence of calcium; if on the contrary, it turns violet, it is a sign that there is no free calcium in the distilled water nor in any of the reagents used. In case of turning red, titrate with 40 ppm (0.01 M) EDTA using a graduated pipette of I milliliter until it changes from red to violet, indicating that all the calcium present in the mixture has been complexed.
(c) Adding I milliliter of the fluid filtrate sample to be analyzed; if there is free calcium present when adding the sample, the solution will turn intense red.
(d) Titrating with 0.5 M EDTA (equivalent to 2000 ppm CaC03), until the solution turns violet, taking note of the volume of EDTA used for titration.
(e) For purposes of calculation of the concentration, multiplying the EDTA volume by 2000, obtaining the result in parts per million of free calcium (ppm of calcium).
(f) If the solution does not turn red, indicating the absence of free calcium in the distilled water or in the reagents used, then proceeding with step (c).

This method using 2000 ppm EDTA can be used a guide for control of free calcium concentration of the drilling fluid according to the present invention.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Drilling Fluid Containing the Cationic Surfactant of the Present Invention

A drilling fluid containing the cationic surfactant of the present invention was made by adding xanthan gum to water, starch, cationic surfactant, calcium oxide, and calcium carbonate to water under agitation in the amounts in pounds per barrel (lbs./bbl.) listed in Table 1. The drilling fluid was tested at different rates of agitation to determine the rheology properties of the fluid with and without contamination using a methylene blue tester. The methylene blue capacity test of a drilling fluid provides an indication of the amount of reactive clay-like material in a water-base drilling fluid based on the amount of methylene blue dye absorbed by the sample. Methylene Blue Test kits are commercially available. Table 2 lists the testing results.

TABLE 1

| | CONCENTRATION (POUNDS PER |
|---|---|
| PRODUCTS | BARREL (LBS/BBL)) |
| XANTHAN GUM | 1.5 LBS/BBL |
| STARCH | 6 LBS/BBL |
| CATIONIC SURFACTANT | 2 VOL % |
| CALCIUM OXIDE | 0.4-1.3 LBS/BBL_{[Ir1]} |
| CALCIUM CARBONATE | 104 LBS/BBL |

TABLE 2

| | | | RHEOLOGY | | | |
|---|---|---|---|---|---|---|
| CONTAM. | | | | | Gels (LBS/ | MBT(LBS ARC./ |
| (lbm/bbl.) | READINGS | | | YP | 100 FT²) | BBL OF FLUID) |
| BENT | L600 | L300 | P V | (LBS/ | 10 SEC/10 | MBT(LBS ARC./ |
| (lbm/BBL) | (RPM) | (RPM) | (CENTIPOIS) | 100 FT²) | MIN/30 MIN | BBL OF FLUID) |
| Without | 62 | 45 | 17 | 28 | 9/9/12 | 0 |
| contaminant | | | | | | |
| C.20 | 77 | 59 | 18 | 41 | 13/19/21 | 12.5 |
| C.30 | 82 | 62 | 20 | 42 | 16/23/26 | 20 |
| C.40 | 116 | 90 | 26 | 64 | 23/33/36 | 25 |

*Methylene blue testing agent

### Example 2

### Comparative Drilling Fluid Absent the Cationic Surfactant of the Present Invention

A drilling fluid absent the cationic surfactant of the present invention was made by adding xanthan gum to water, starch, calcium oxide, and calcium carbonate to water under agitation in the amounts listed in Table 3 lists. The drilling fluid was tested at different rates of agitation to determine the rheology properties of the fluid with and without contamination. Table 4 lists the testing results.

TABLE 3

| | CONCENTRATION (POUNDS PER |
|---|---|
| PRODUCTS | BARREL (LBS/BBL) |
| XANTHAN GUM | 1.5 LBS/BBL |
| STARCH | 6 LBS/BBL |
| CATIONIC SURFACTANT | 0 |
| CALCIUM OXIDE | 0 4-1.3 LBS/BBL_{[Ir2]} |
| CALCIUM CARBONATE | 104 LBS/BBL |

TABLE 4

| | | | RHEOLOGY | | | |
|---|---|---|---|---|---|---|
| CONTAM. | | | | | Gels (LBS/ | MBT(LBS ARC./ |
| (lbm/bbl.) | READINGS | | | YP | 100 FT²) | BBL OF FLUID) |
| BENT | L600 | L300 | PV | (LBS/ | 10 SEC/10 | MBT(LBS ARC./ |
| (lbm/BBL) | (RPM) | (RPM) | (CENTIPOIS) | 100 FT²) | MIN/30 MIN. | BBL OF FLUID) |
| Without | 62 | 45 | 17 | 28 | 9/9/12 | 0 |
| contaminant | | | | | | |
| C.20 | 77 | 59 | 18 | 41 | 13/19/21 | 20 |
| C.30 | 300 | 242 | ? | ? | 70/105/? | 30 |

| | | |
|---|---|---|
| C.40 | UNREADABLE, COMPLETELY GELIFIED | 40 |

*Methylene blue testing agent

### Comparison of Testing Results

When comparing the results in Table 2, Example 1, with the cationic surfactant of the present invention with those obtained in Table 4, Example 2, absent said cationic surfactant, the effect caused by the presence of the cationic surfactant was determined. In the formulation of the fluid rheology, especially the effects of the contaminant, which simulated the incorporation of forming clay into the fluid when drilling; in addition to the effect on the rheological properties, the effect on the MBT (methylene blue tester) test where both fluid samples were contaminated with: 20, 30 and 40 lbs./bbl. of commercial bentonite (bentonite or montmorillonite sodium is the most important active component of lithology of different layers that are crossed during the drilling of a well and the main responsible for the swelling by water absorption of the clays and shales that cause so many difficulties in the drilling of an oil or gas well) was apparent. The results of the MBT test in Table 2 show the following: C20: 12.5 MBT; C30: 20 MBT; C40: 25 MBT; in (t2) C20: 20 MBT; C30: 30 MBT; C40: 40 MBT, the difference of (7.5; 10 and 15) lbs. of arc./bbl. of fluid) between the bentonite added as contaminant and what was detected in Table 2 through the MBT indicated the capacity of the surfactant in the formulation of fluid Table 2 to modify the active center of the clay particle through the cationic exchange by substitution of Ca++ with Na+, this difference of values in the Tables 2 and 4 between the MBT and the contaminant represented the amount of sodium montmorillonite transformed into calcium montmorillonite with lower water absorption capacity, because when Na+ is displaced from the active center of the clay particle, it drags water and Ca++, having less chemical activity and less hydrodynamic potential, it fixed less water than Na+, reducing the swelling of the clay, the well diameter and incorporation of sodium clay into the drilling fluid prepared in accordance with this formulation.

### Example 3

### Linear Swelling Data for the Drilling Fluid of the Present Invention

The wellbore instability problems generated as a result of the contact between drilling fluid and clay formations have been studied for several years; however, the complexity of the behavior of argillaceous rocks makes their analysis difficult. For this reason, it is important and necessary to propose a possible solution by means of experimental testing using as an instrument of measurement “strain gages” in order to determine the linear swelling of clays in contact with different drilling fluids. The main objective of this procedure is to propose a methodology based on laboratory tests to determine the linear swelling of the clays in drill cuttings using displacement sensors as the “strain gages.”

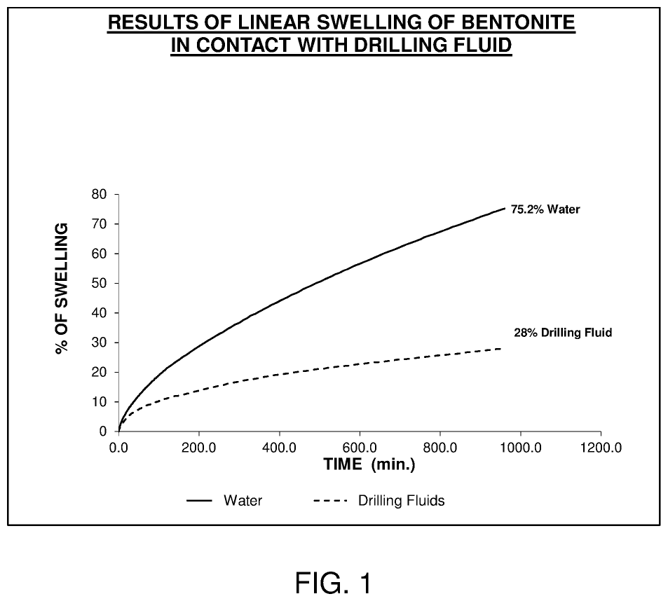

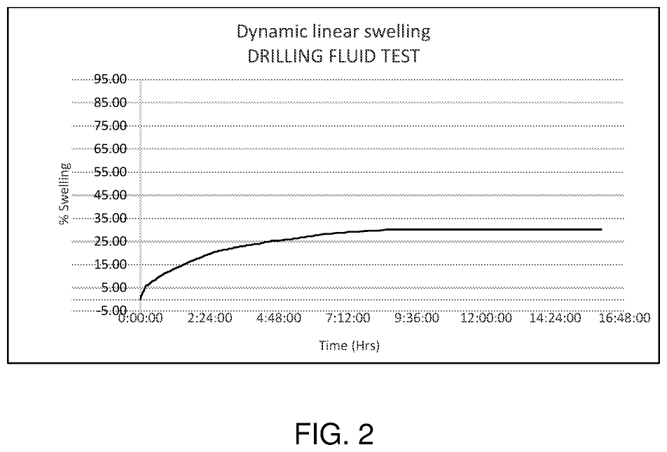

The drilling fluid of the present invention was tested to determine the linear swelling percentage using the Linear Swell Meter (LSM) test. This test is used to determine the linear volume of water absorption of a sample of commercial bentonite, clay, cuttings or samples of formation that has not been exposed to drilling fluid. Such Figures are constructed from the experimental data listed in Table 5. FIGS. 1 and 2 are graphs of the data listed in Table 5.

TABLE 5
DRILLING FLUID
LINEAR SWELLING % DATA

| Time | Water | Fluid with DRILLING FLUID |
|---|---|---|
| 0.0 | 0 | 0 |
| 1.0 | 0.8 | 0.66 |
| 2.0 | 1.4 | 1 |
| 3.0 | 1.8 | 1.3 |
| 4.0 | 2.3 | 1.7 |
| 5.0 | 2.7 | 1.9 |
| 6.0 | 3 | 2.1 |
| 7.0 | 3.4 | 2.4 |
| 8.0 | 3.7 | 2.5 |
| 9.0 | 4 | 2.7 |
| 10.0 | 4.3 | 2.8 |
| 11.0 | 4.6 | 3.2 |
| 12.0 | 4.9 | 3.3 |
| 13.0 | 5.1 | 3.4 |
| 14.0 | 5.3 | 3.6 |
| 15.0 | 5.5 | 3.8 |
| 16.0 | 5.8 | 4 |

The results obtained from this test to evaluate the efficiency of the drilling fluid according to the present invention are related to reducing the swelling capacity of the clays and shales, and hence are considered excellent.

### Field Test

### (% V/V and Pounds Per Barrel (lbs./bbl.) Vs. Ca⁺² Concentration in ppm)

In field tests, the product performed satisfactorily. The results obtained during the drilling of the intermediate section of several wells (12.25 inches) allowed to confirm the effects of the present formulation; in which between 600-980 feet of the producing or reservoir section were drilled, where up to between 2-3% of crude equivalent to between 44-66 barrels of crude oil were incorporated, this volume of crude oil incorporated into the fluid was efficiently emulsified without affect the rheological properties of the fluid as well as not significantly affect the physical properties, nor presented accretion, or plugging of flow lines or the meshes of the solids control equipment. Accretion implies the growth of a body by aggregation of minor bodies

When establishing comparisons, it was determined that a reduction in the volume of incorporation of plastic or bentonite clays between 50-60% of the total average of the incorporated when other clay inhibitors are used. This was confirmed by the MBT analysis (Methylene Blue Test).

Likewise, it showed capacity of cationic exchange of the active center of the clay particle, quality that the sodium montmorillonites possess, this allows them to modify their chemical structure converting them in this case into calcium montmorillonites; which have lower water absorption capacity, which affects less swelling capacity.

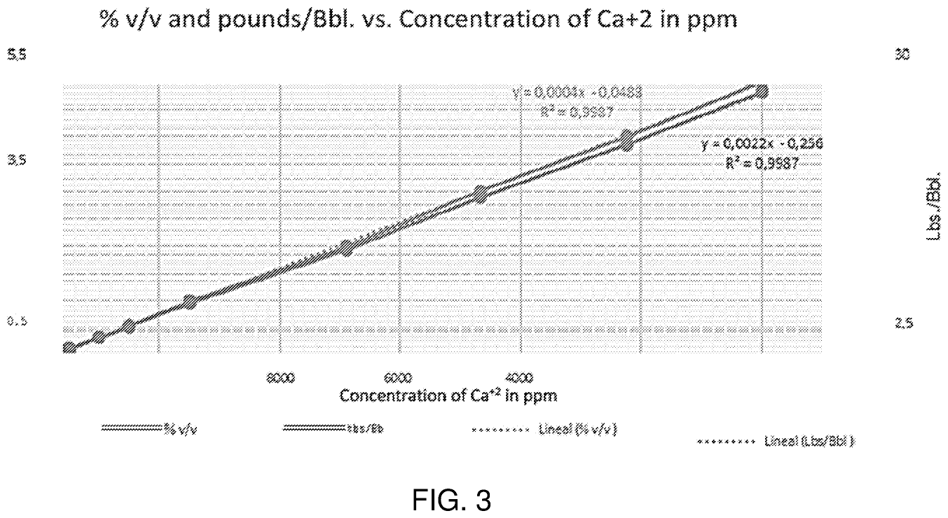

The following table that can be interpreted with FIG. 3, reflects the results of the field tests:

TABLE 6
(% V/V & LBS/BBL VS. CA⁺² CONCENTRATION)
% v/v & Lbs/Bbl. Vs. Ca⁺² Concentration in ppm

| Ca⁺⁺ (ppm) | Lbs/Bbl. | % v/v |
|---|---|---|
| 500 | 0.84 | 0.15 |
| 1000 | 1.94 | 0.35 |
| 1500 | 3.04 | 0.55 |
| 2500 | 5.25 | 1 |
| 5100 | 10.5 | 2 |
| 7320 | 15.75 | 3 |
| 9760 | 21 | 4 |
| 12000 | 26.25 | 5 |

ppm = parts per million

1. A cationic surfactant composition comprising calcium nitrate, diethanolamine and glacial acetic acid, wherein the cationic surfactant composition is capable of inhibiting precipitation of asphaltenes during a hydrocarbon drilling operation.

2. The surfactant of claim 1, comprising 2 to 5 vol. % of diethanolamine, 0.5 to 2 vol. % acetic acid, and 92 to 97 vol. % of a calcium nitrate solution including 54 to 57 vol. % calcium nitrate.

3. The surfactant of claim 1, consisting essentially of: 1 to 5 vol. % of diethanolamine, 0.5 to 2 vol. % acetic acid, and 92 to 97 vol. % of a calcium nitrate solution including 54 to 57 vol. % calcium nitrate.

4. A method of making a cationic surfactant, the method comprising:
(a) preparing calcium nitrate from a reaction between nitric acid in a concentration between 56 wt. % and 66 wt. % and calcium carbonate in a concentration between 96 wt. % and 99 wt. %;
(b) adding an alkalizing agent to step (a) to neutralize or adjust the pH;
(c) obtaining a calcium nitrate solution in a concentration between 54 vol % and 57 vol %;
(d) adding diethanolamine to the calcium nitrate solution; and
(e) adding glacial acetic acid to form the cationic surfactant.

5. A drilling fluid comprising the cationic surfactant according to claim 1.

6. The drilling fluid of claim 5, further comprising a viscosifier.

7. The drilling fluid of claim 6, wherein the viscosifier is xanthan gum.

8. The drilling fluid of claim 7, comprising 1.2-1.6 lbm/bbl. (3.42 to 4.56 kg/m) of viscosifier.

9. The drilling fluid of claim 5, further comprising starch as a filtration control agent.

10. The drilling fluid of claim 9, comprising 6 lbm/bbl. (17.1 kg/m) of starch.

11. The drilling fluid of claim 5, comprising an alkalizing agent selected from the group consisting of calcium oxide, lime, magnesium oxide, magnesium peroxide, or mixtures thereof.

12. The drilling fluid of claim 11, wherein the alkalizing agent is calcium oxide.

13. The drilling fluid of claim 12, comprising 0.4 to 1.4 lbm/bbl. (1.14 to 3.99 kg/m³ of calcium oxide.

14. The drilling fluid of claim 5, further comprising a densifier.

15. The drilling fluid of claim 14, wherein the densifier comprises calcium carbonate, barite, galena, and/or hematite.

16. The drilling fluid of claim 14, comprising 95 to 105 lbm/bbl. (270-299.24 kg/m³) of calcium carbonate and drilling fluid of 10.0 pounds per gallon, wherein the amount of such densifier is a function of the density required up to 11.2 pounds per gallon.

17. The drilling fluid of claim 5, consisting essentially of:
1 to 5 vol. % of the cationic surfactant of any one of claims 1 to 3;
an alkalizing agent;
starch;
a viscosifier; and
an optional densifier.

18. A method to prepare a drilling fluid, comprising the steps of:
(a) adding to the preparation tank a volume of water needed to prepare the required volume of the drilling fluid;
(b) adding sufficient viscosifier to achieve a viscosifier concentration of 1.2-1.6 lbm/bbl. (3.42 to 4.56 kg/m³) at a rate sufficient to disperse the viscosifier in the water without gelation;
(c) adding 1 to 5 vol. %, preferably 2 vol. % of the cationic surfactant of any one of claims 1 to 3;
(d) adding a sufficient amount of calcium oxide to obtain an calcium oxide equivalence of 38-49 lbm (17.2 to 22.2 kg) of calcium oxide per each barrel of fluid of 10 lbs/gal; and
(e) adding a sufficient amount of densifier to obtain a densifier concentration of 95 to 105 lbm/bbl. (270.8 to 299.3 kg/m3.

19. A method for controlling the free calcium in a drilling fluid of claim 5 in a wellbore drilling operation comprising the following steps:
(a) obtaining an basic solution comprising water, a calcium indicator, and analyte comprising calcium ions; and
(b) adding a volume of 0.5 molar (M) ethylenediaminetetraacetic acid (EDTA) to the solution until a visual endpoint is obtained; and
(c) determining the parts per million of free calcium in the analyte by multiplying the EDTA volume from step (c) by 2000.

20. The method of claim 19, wherein the analyte is comprised in a drilling fluid obtained from a wellbore.
